(19) United States
(12) Patent Application Publication
(10) Pub. No.: US 2004/0091846 A1
(43) Pub. Date: May 13, 2004

(54) E-learning incentive system, apparatus and methodology

(75) Inventors: Robert S. Aughenbaugh, Portland, OR (US); Bruce A. Carocci, West Linn, OR (US)

Correspondence Address: Robert D. Varitz, ROBERT D. VARITZ, P.C., 2007 S.E. Grant Street, Portland, OR, 97214, US

(73) Assignee: Via Training, L.L.C.

(21) Appl. No.: 10/290,670

(22) Filed: Nov. 7, 2002

(51) Int. Cl. G09B 3/00

(52) U.S. Cl. 434/350

(57) ABSTRACT

Apparatus and methodology employable in an e-learning environment which links with a selected e-learning management system to respond to e-learning benchmarks, and other events relating to e-learning activities, by offering buildable student bank accounts of value points which can be redeemed for various incentive awards that are made known and available to a participating student via a virtual store which is configurable freely to show and describe, and to present values of, such awards. Award inventory, award value, and the relationship which exists between made-available awards and particular benchmarked learning activities, or other events, are freely and widely reconfigurable and modifiable in various ways by a host who manages and configures the system and methodology of the invention.

### GENERAL INTRODUCTION

This invention relates to the so-called field of electronic learning, referred to hereinafter as e-learning, and in particular, to a system, apparatus and methodology for offering, electronically, various incentives for promoting a student's e-learning activities. While there are many specific settings and applications wherein the present invention has utility, a preferred embodiment and manner of practicing the invention are described herein in the setting, as an illustration, of furnishing learning incentives to corporate sales employees in relation to their improving things such as corporate product-understanding, sales techniques and approaches, and other associated customer-relation and sales skills.

Included in the invention, from a systemic and apparatus point of view, is interface structure which is designed to be connectable to a conventional e-learning management system, the specific components of which are not per se any part of the present invention. Such a connection is made for the purpose of receiving appropriate information from that learning management system regarding various identified e-learning activities of students who are engaged with one or more e-learning subject areas. For example, information from such a management system might typically report, among a number of other things, that a particular student has, on a certain date, and/or over a certain period of time, and/or in a certain pattern of engagement, participated in and completed certain specified-subject e-learning activities. This information, as well as information (still to be described) relating to other kinds of events and activities, is employed, in accordance with practice of the present invention, to establish a student-specific, point-count “award bank deposit” from which a progressing e-learning student can “withdraw” and “spend” specified numbers of previously deposited points to acquire various incentive awards, such as products, special trips, and other “award items”, as determined by the party hosting and managing the related incentive system. The relationship which exists between an incentivized e-learning activity and an associated incentive award is referred to herein as being a point-count relationship.

Configuration and management of the incentive system of this invention can be performed to give the system, as far as an engaging student is concerned, various kinds of specific looks and feels. It can be constructed, and modified when desired, to offer an array of different kinds of awards which are keyed to easily selectable and re-designable e-learning accomplishment benchmarks (events which are assigned certain point values), as determined by the configuring and managing, hosting party. System management, according to the invention, includes, among other things, providing for the creation and obtaining of various kinds of event/activity/inventory/etc. reports, such as reports regarding (a) points awarded in some unit of time, (b) points “liability” in terms of “callable” awards, (c) specific inventory levels of various items, (d) “hot” items, (e) “lesser-interest” items, etc. The party performing such management function is referred to herein as a host. Typically, the hosting party will be either third-party provider of incentive-promotion capability, or the employer per se of the student participating in incentivized e-learning activity.

When a student engaged in an e-learning activity which is being monitored by the incentive structure of this invention completes various particular activities, the interface mentioned earlier receives information (a trigger occurrence) about that student's progress and accomplishments. In accordance with a point-value schedule which has been determined by the host of the incentive system, the student's “e-point bank account” is incremented by a certain point value, with the student then having the opportunity, at any moment in time, and through network communication with that bank account, to monitor bank-account point balance, and also to peruse the offerings of incentive awards through a virtual “store” which is made available to participating students. When a student has achieved a point-value accomplishment level which matches with a particular award made available for that level of accomplishment, the student can elect to request that award, which request is appropriately communicated, typically via e-network communication, to a suitable fulfillment “organization” which then delivers the earned and requested award to the student. Redeeming of earned and banked points causes a decrementing withdrawal to take place from the student's point-value bank account.

The system and methodology for incentivizing e-learning activities, in accordance with this invention, is highly and very freely re-configurable and manageable to respond to various e-learning accomplishments with various kinds of incentive awards. Preferably the system of the invention is maintained in a condition wherein it is readily coupleable and de-coupleable from one or many e-learning management systems so that it can be prepared to respond appropriately to different kinds and styles of e-learning activities that are “managed” and followed by such an associated learning management system, or systems. It is also possible, of course, for the system and methodology of this invention selectively to become dedicatedly connected, for different periods of time, to particular e-learning management systems, if that is what a user of the invention wishes.

Various other features and advantages that are offered by the present invention will become more fully apparent as the description which now follows is read in conjunction with the accompanying drawings.

### DESCRIPTION OF THE DRAWINGS

FIG. 1 is a block/schematic diagram illustrating a preferred embodiment and manner of practicing the present invention in the setting of a particular external e-learning management system which is designed to follow e-learning activities of various students who are given the opportunity to engage in a particular selection of e-learning activities.

FIG. 2 is a block/schematic diagram focusing attention on the internal structure and operation of the e-learning incentivizing portions of the system and methodology of the present invention.

FIG. 3 is a block/schematic diagram illustrating generally further details of the two blocks in FIG. 2 which are labeled “Look-Up Activity Table” and “Activity Value”.

### DETAILED DESCRIPTION OF THE INVENTION

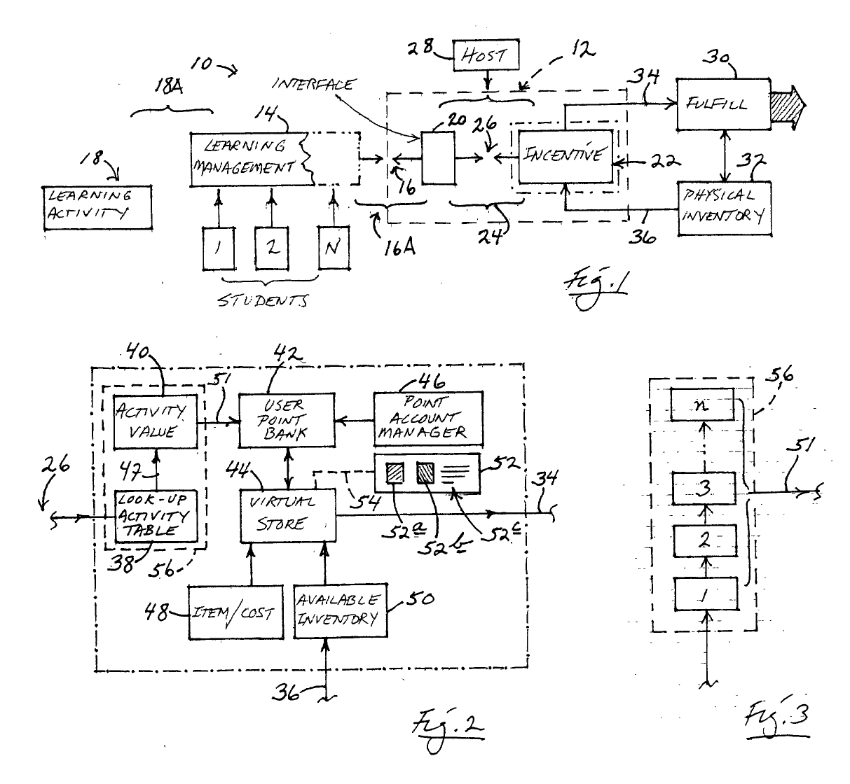

Turning now to the drawings, and referring first of all to FIG. 1, here, illustrated generally at 10, is an e-learning environment which includes incentivizing apparatus 12 which is made in accordance with a preferred embodiment of the present invention, which apparatus is shown in FIG. 1 to be cooperating with a conventional e-learning management system, or structure, 14. The two arrows which point toward one another at location 16 herein illustrate a circumstance wherein apparatus 12 and management system 14 are connectable and interconnectable with one another, with the double arrow heads being interpretable as reflecting a circumstance where, in fact, these two things are directly connected to one another for cooperation. A bracket 16A is employed in FIG. 1 to represent another circumstance wherein, in a specialized e-learning environment, apparatus 12 and learning management system 14 are dedicatedly coupled to one another.

Shown in FIG. 1 by blocks labeled internally 1, 2 and N are three different students who are coupled operatively to learning management system 14 for the purpose of engaging in different selected e-learning activities contained within a block in FIG. 1 which is referenced by number 18. For the purpose of illustration herein, the various learning activities which are made available to students via block 18 are activities specifically associated with the field of product sales. Each of the illustrated students is offered the opportunity to elect to engage in an e-learning activity selected from within block 18, which engagement will be monitored by learning management system 14. A bracket shown at 18A in FIG. 1 represents an operative interconnection between blocks 14, 18.

According to the practice of the invention, specific activities that are engaged in by students are reported in various different ways by management system 14 through connection 16 to apparatus 12. There are many different kinds of activities and/or events which can be reported through this connection and several illustrations include reports that relate (a) to the completion of a particular learning activity by a given student, (b) to the completion of that activity in conjunction with prior completions of other e-learning activities, (c) to the completion of a selected learning activity within a certain period of time, or at a certain particular point in time, (d) to the length of time taken by a student to complete a particular selected learning activity, and so on.

Included in apparatus 12 in accordance with this invention are a reporting interface structure 20 which is connected to receive information directly from learning management system 14, and an e-learning incentive generator 22. A bracket 24 represents the presence of an operative connection 26 between interface 20 and incentive generator 22.

Shown immediately adjacent the upper and right sides of apparatus 12 in FIG. 1, are three blocks, 28, 30, 32 which represent, respectively, (a) a Host for implementing selectable reconfiguration and management, as will shortly be discussed, of and within the character of apparatus 12, (b) an award fulfillment system which is connected, as shown at 34, to generator 22 for the purpose of implementing a student or user selection of an e-learning incentivized award, and (c) physical inventory of available awards operatively coupled to generator 22 though a connection shown at 36.

Host 28 represents herein two different specific hosting entities, one of which might be a third party (remote) provider of incentivizing award management to a corporate employer subscriber for use of the apparatus embodied in block 12, or the hosting entity might just as well be that corporate employer (local, or self) per se. Hosting activities include both acts of configuration and management with respect to the character and operation of what is contained in apparatus 12. An illustration of such hosting activity includes (a) adding to and subtracting from, or modifying, awards that are to be made available for the completions of different kinds of e-learning student activities or events, (b) the variable establishing of point-value counts which will relate to the opportunity provided to an e-learning student for acquiring certain incentive awards, and (c) the establishing of recognizable extraneous events, such as noting that a current e-learning student has referred another student for use of the elements shown in environment 10. Thus, for example, a student might be entitled to receive a complimentary point count of some selected value simply by having encouraged another prospective student to begin employing apparatus 12 in conjunction with learning activities drawn from block 18. A hosting party can also make other changes, such as, for example, changes in the overall look and feel of the particular interface or interfaces that are presented to a student user employing the system (and methodology) of this invention. The connection which exists between Host 28 and block 12 is referred to herein as a hosting input. This same connection is also referred to herein both as a structure for assigning reward-item values, and as a structure for assigning e-learning accomplishment values.

Another aspect of hosting includes enabling and practicing the creation and delivery of different, selectable management reports, such as reports relating to (a) the number of points which have been earned/delivered during a particular time period, (b) the current level of points “liability” regarding earned but yet unredeemed points, (c) current inventory levels of awardable awards, and so on.

It should be mentioned here that the various different kinds of connections that are shown between certain blocks pictured in FIG. 1 are preferably, though not necessarily, network type connections, including an Internet type connection, and various local area or wider-area network connections. The type of such a connection is not important to implementation and practice of the present invention.

In general terms, a student who is positioned to engage in selected e-learning activities from block 18, has what is referred to herein as a point-value bank account created within block 22 for the purpose of collecting value points in relation to completions of activities, such as those which have been mentioned above. When the student, in relation to engagement with an e-learning activity, completes certain tasks, and/or passes certain benchmarks of activity, the connection established between blocks 12, 14 results in a report being given to the structure within block 12 which, if related to a student activity for which incentive points can be awarded, causes the right number of such points to be “deposited” in that student's bank account of incentive value points. At any point in time wherein a student wishes to review, and perhaps make use of, banked value points, that student can easily gain access to his or her “bank account”, note the number of points, and ask to review potentially available awards, and their values, for the purpose of making a selection to receive an award, if the appropriate number of value points are available to do that.

When a student elects to receive an award based upon having chosen one from those that are available, the user's determination to do this is communicated to fulfillment block 30, invocation of which results in the selected award being “delivered” to the student. Selection and redemption of value points for awards causes a particular student's bank account balance to be decremented by the number of points required to obtain the selected award. The fulfillment block works in conjunction with physical inventory block 32 for the purpose of being certain that a deliverable award in the category requested is available, and also that there is an appropriate interaction with inventory block 32 to adjust the level of available inventory accordingly. The interconnection between blocks 30, 32 also, of course, allows the fulfillment block to “know” whether and what awards at any moment in time are available.

As was mentioned above in the description of the several drawing figures, the componentry illustrated in FIGS. 2 and 3 further details pieces and parts of the contents of block 12. One will note in FIG. 1 that block 22 is outlined by dash-dot lines, and that this very same character of outline is shown in FIG. 2 for the purpose of relating the componentry shown in FIG. 2 to the region in block 12 in FIG. 1 where this componentry sits, namely, within incentive generator block 22.

What is shown in FIG. 3, and what is surrounded therein by dashed lines, relates to the two blocks in FIG. 2 which are also surrounded by dashed lines—namely, the two blocks labeled “ACTIVITY VALUE” and “LOOK-UP ACTIVITY TABLE”.

Thus, the several blocks which are directly pictured in FIG. 2 include a Look-Up Activity Table block 38, an Activity Value block 40, a User Point Bank block 42, a Virtual Store block 44, a Point Account Manager block 46, an Item/Cost block 48, and an Available Inventory block 50. Blocks 38, 40 are shown connected through an arrow-headed line 47. Also illustrated within the confines of the outlined componentry pictured in FIG. 2 is a block 52 which represents an external user interface, such as a web-browser interface, which is operatively connected to the virtual store block by a dashed line 54. Previously mentioned connections 34. 36, and connection 26 originally discussed with respect to FIG. 1, are also generally shown in FIG. 2.

Referring now specifically to FIG. 3, here, shown within a dashed-line rectangle 56 (which is also so pictured in FIG. 2) are elements which can be thought of as being different parts of blocks 38, 40 in FIG. 2. In FIG. 3, the blocks which are numbered internally 1, 2 and 3, and n represent specific e-learning activities, and associated point values, which have been configured and designated by a host, such as previously mentioned Host 28. These activities and events directly relate to different categories of awardable, incentivized activities, like those mentioned earlier herein.

Effectively, when a student user is engaged with, or has just been engaged with, an e-learning activity drawn from block 18, that fact, and the specific engaged-in activity, are reported through connection 16 and interface 20 (FIG. 1) to block 38 which operates like a look up table to define which if any of the specified and point-valued activities (see FIG. 3) have been engaged in with benchmarks passed. An appropriately designated activity causes a report to be delivered to block 40 on completion of that activity, and a new additional point-value count is deposited in that student user's bank account, represented by block 42 in FIG. 2.

Whenever that student/user wishes to ascertain what balance of value points exists in his or her bank account, that student simply calls up for a report from the appropriate bank account, whereupon he or she can see exactly the number of points, and perhaps the categories of points, that are available to that student for use with respect to redeeming incentive awards.

The student can also gain access to the virtual store represented by block 44 to see just what different awards may be available at that point in time in relation to the bank account value of accumulated points in that student's bank account. Information provided by the virtual store is based upon, at least in part, information furnished from (a) block 48, and (b) through block 50 from physical inventory block 32, thus arming the virtual store to be aware of available inventory, and also to be aware of the associated and assigned point value levels assigned to each such activity.

Through an appropriate external user interface, such as a web browser interface like that suggested by block 52 in FIG. 2, the student user is enabled, as an illustration, to view the contents available through the virtual store in both imagery and text forms. Accordingly, pictured within block 52 in FIG. 2 are two images 52a, 52b, and text 52c which might, for example, generally describe what is shown in that imagery.

When a student user acts to redeem a certain point value for the purpose of receiving a related award, this wish is communicated via previously mentioned connection 34 to fulfillment block 30 which then, under the management of appropriate fulfillment personnel wherever, responds to that request by fulfilling the redemption “order”.

It will thus be apparent that the system and methodology proposed by this invention uniquely link award-incentivizing capability to an associated e-learning management system with respect to selected e-learning activities engaged in by various different participating students. The benchmarks, for example, which are decided upon as worthy of incentivizing and linking to awards are freely and widely selectable and configurable at any time by an incentive host. And indeed, the entire complexion, look and feel, internal operating characteristics, etc., of the incentive system of this invention are readily changeable/reconfigurable at any selected time.

Preferably, the apparatus of this invention is freely coupleable and uncoupleable at will with one or more e-learning management systems, such as system 14. In certain instances, however, a user of the invention may wish to create a more dedicated, but nevertheless modifiable, connection between a specific e-learning management system and the incentivizing structure of the invention, and this is entirely doable.

It should be understood that what has been described above with reference to FIGS. 1, 2 and 3, and particularly what has been described in a systemic, apparatus manner, also operates fully to describe the methodology of the present invention. Accordingly, what is pictured in FIGS. 1, 2 and 3 can be viewed as reflecting method components of this invention.

Also, it will be readily apparent to those generally skilled in the art that there are many different ways to implement, typically by way of software, the structures and activities pictured within FIGS. 1, 2 and 3, and accordingly, no great detail is given herein with respect to the internal makeup and workings of these various pictured structural and activity blocks.

Thus, while a preferred embodiment of the invention, and a preferred manner of practicing the same, have been specifically illustrated and described herein, it is appreciated that variations and modifications may be made without departing form the spirit of this invention.

We claim:

1. Apparatus employable in an e-learning environment which includes a user-accessible e-learning activity, and an e-learning management structure capable of tracking, at least in certain respects, a user's pattern of engagement with that activity, said apparatus comprising
reporting interface structure operatively connectable to said management structure, operable to furnish selected reports regarding such a user's engagement pattern with the activity, and
an e-learning incentive generator operatively connectable to said interface structure in a manner of connection which is selectable from the range of options including (a) inherently dedicated, and (b) inherently non-dedicated, said generator being configurable for receiving such selected reports, and for exposing to the user appropriate c-learning incentives which relate to the user's engagement with the activity as reflected in the selected reports.

2. The apparatus of claim 1, wherein said incentive generator includes a hosting input constructed to enable, selectively, both local (self) and remote (third-party) configuring and managing of generator behavior, including specifying the offering of particular award incentives in relation to a user's accomplished e-learning activity(ies).

3. The apparatus of claim 1, wherein said hosting input is constructed to permit the preparation and delivery of different, selectable apparatus-related management reports.

4. The apparatus of claim 1 which is operatively connectable to an incentive award fulfillment system.

5. The apparatus of claim 1, wherein said incentive generator includes an inventory-manageable virtual store of incentive rewards, and associated with that store, (a) structure for assigning reward-item values, and (b) structure for assigning e-learning accomplishment values which are employable by a user, in relation to virtual store inventory, and to assigned reward-item values, to request an incentive award.

6. The apparatus of claim 5, wherein said values are point-count values.

7. The apparatus of claim 5, wherein said virtual store is capable of presenting to a user at least one of (a) image and (b) text descriptions of available incentive awards.

8. The apparatus of claim 1, wherein said incentive generator includes freely changeable scheduling structure which enables the generator to offer different award responses to a student based upon different, selectable patterns of e-learning accomplishments.

9. A method for employing e-learning incentives for a user of an e-learning activity, where, associated with that activity, there is an e-learning management structure that is capable of tracking, at least in certain respects, the user's pattern of engagement with that activity, said method comprising,
reporting, selectively, the user's tracked engagement pattern with the activity, and
based upon said reporting, exposing to the user, in a potentially time-variant, selectively engagable manner, appropriate incentive awards which are, at that point in time, selectively related to such activity engagement.

10. The method of claim 9 which further includes enabling the selective making of changes in one or more of (a) changing the content and/or nature of incentivized activities, and (b) changing the incentivizing value relationship between an incentivized activity and its associated incentivizing award.

11. The method of claim 9 which further includes offering to a user for viewing a virtual store stocked with activity-related incentive awards.

12. The method of claim 9 which further includes enabling the preparation and delivery of different, selectable management reports.

13. The method of claim 9, wherein the relationship which exists between an incentivized e-learning activity and an associated incentive award can be described as being a point-count relationship.

14. The method of claim 13, wherein the mentioned point-count relationship is handled via a banking deposit and withdrawal analogy.
